(19) United States
(12) Patent Application Publication
(10) Pub. No.: US 2020/0122988 A1
(43) Pub. Date: Apr. 23, 2020

(54) CONFIGURABLE LIFT SYSTEM

(71) Applicant: Bary Sanford Boggess, North Ogden, UT (US)

(72) Inventor: Bary Sanford Boggess, North Ogden, UT (US)

(21) Appl. No.: 16/687,600

(22) Filed: Nov. 18, 2019

Related U.S. Application Data
(60) Provisional application No. 62/748,428, filed on Oct. 20, 2018.

(51) Int. Cl. B66F 7/28

(52) U.S. Cl. CPC B66F 7/28

(57) ABSTRACT

A lift system including an extendable column mounted to a wall or free standing on which rides one or more carriages that are raised and lowered by a lifting mechanism. The carriages are removable and capable of having various attachments.

### TECHNICAL FIELD

The disclosure relates to the field of lift systems and more particularly to a configurable minimalist lift system.

### BACKGROUND

Lift systems are often used to position items such as a vehicle at a height that makes it more convenient to do work on them or inspect areas that are inconvenient to access when on the ground. Lift systems are also used to raise items off the ground for storage or temporary relocation to a position above the ground to free up floor space for other uses such as vehicle parking. Lift systems are also commonly employed to ergonomically position work benches at a height to suit a user's comfortable working height. All of these forms of lift exist independently but the present disclosure of a configurable lift system makes it convenient to configure the lift for any of the above uses or mixing any of the above uses while maintaining a minimalistic approach that results in a versatile lift system that occupies very little space, is easy to use and is expandable to accommodate various applications.

### SUMMARY

Embodiments of the lift system are versatile, space saving, expandable and configurable. According to an embodiment, the lift system includes a column standing vertically that sits on a support surface and is attached to a wall or other structure. Attached to the column is a lifting mechanism arranged to raise and lower one or more carriages that travel vertically along the column.

According to a variation, the column has rails that engage rollers or sliders attached to the carriage and guide one or more carriages as they travel along the column. Additional carriages can be quickly and easily attached to or detached from the guide rails so that more than a single carriage may be engaged on the guide rails at a time. The carriages are equipped with a receiver tube or other means for attaching various different accessory attachments.

According to a variation, the lift system can include one or more accessory attachments that can be easily and selectively added to or removed from a carriage to reconfigure it for different applications. The various different attachments may include for example a platform to which a motorcycle can be secured, a bicycle rack, a work bench, kayak rack, cargo basket or others. The ability to add additional carriages and attach accessories to the carriages makes it possible for multiple attachments to be used at a time which increases the capabilities and variety of uses at a time.

According to a variation, the column is segmented and can have extension segments removably attached to vary the height of the column.

According to a variation the column is freestanding.

### BRIEF DESCRIPTION OF THE DRAWINGS

These and other features, aspects, and advantages of the present disclosure will become better understood regarding the following description, appended claims and accompanying drawings.

FIG. 1 shows two views of the lift system according to an embodiment. One with no attachments and the other with an attachment intended for securing and lifting motorcycles.

FIG. 2 shows an exploded view demonstrating how the lift system is modular and can be expanded.

FIG. 3 shows a detail view of a possible guide track and roller design.

FIG. 4 demonstrates how two or more dirt bike motorcycles can be raised for storage in a stacked formation.

### DETAILED DESCRIPTION

It will be understood that, unless a term is expressly defined in this disclosure to possess a described meaning, there is no intent to limit the meaning of such term, either expressly or indirectly, beyond its plain or ordinary meaning.

Any element in a claim that does not explicitly state “means for” performing a specified function, or “step for” performing a specific function, is not to be interpreted as a “means” or “step” clause as specified in 35 U.S.C. § 112, paragraph 6.

The present invention, a configurable lift system, is a versatile and compact lift that can be fitted with multiple carriages allowing for multiple cargo loads to be raised off the floor in succession in an over/under or stacked arrangement.

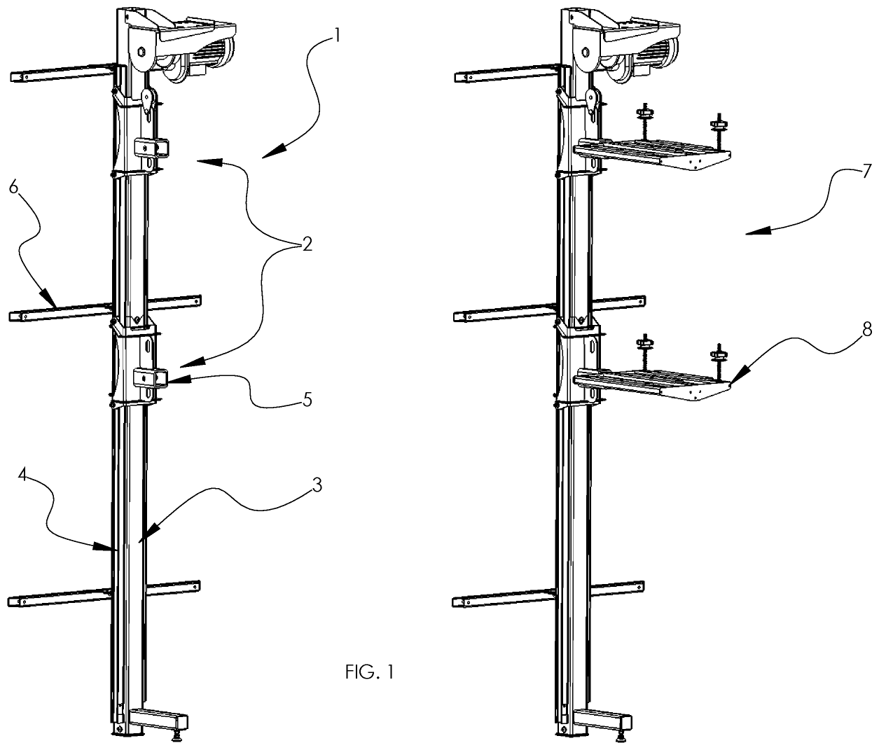

In FIG. 1 we see depicted the lift system 1 with carriages 2 that are guided up and down the column 3 by the guide rails 4. The receiver tubes 5 of the carriages are shown without any accessory attachment installed. The Lift system may be mounted to a wall or other supporting structure or be free standing. The embodiment of FIG. 1 is shown using wall mounting bars 6. Also depicted is the same embodiment in a different view 7 with possible accessory attachments 8 used for securing and lifting motorcycles.

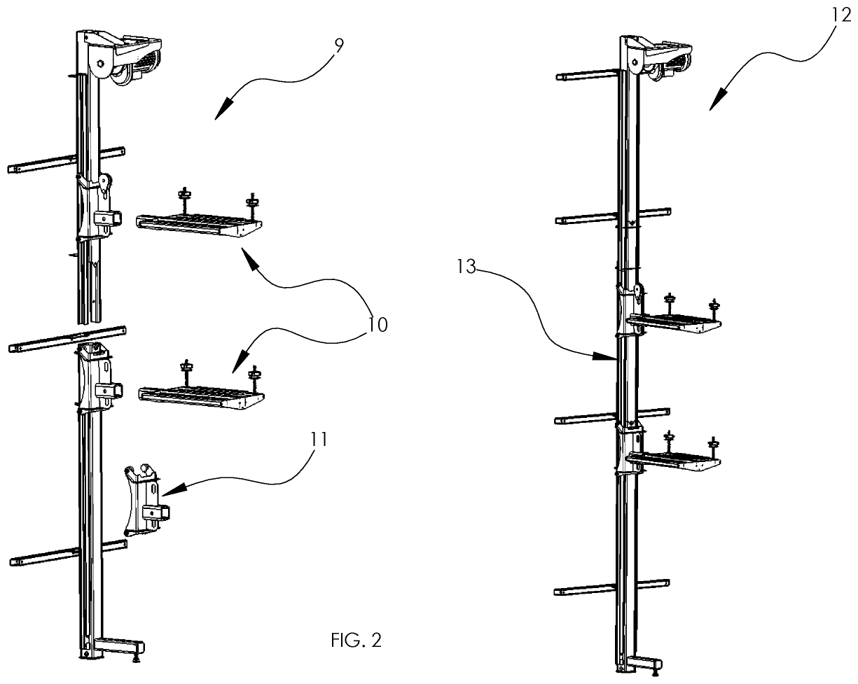

FIG. 2 shows an exploded view 9 which demonstrates how the lift system is modular and extendable. A variety of accessory attachments such as the motorcycle platforms 10 can be attached or detached and replaced with other accessory attachments as desired. Also, carriages 11 can be added or removed. The assembly 12 is shown with an extension section 13 added for additional height capacity.

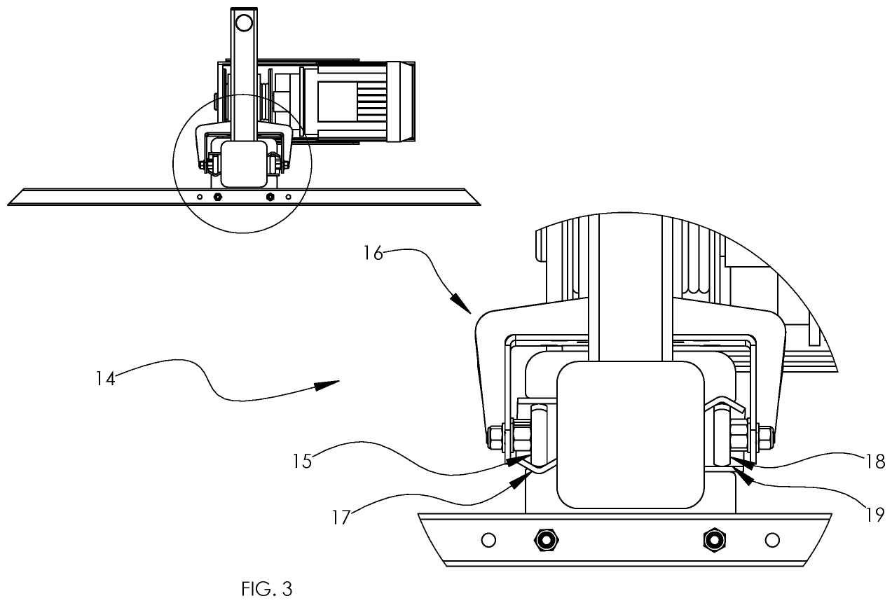

FIG. 3 shows a detail view 14 of a track and roller design where the roller 15 of one side of the carriage 16 is guided by the V of the track 17 while the roller 18 of the other side can vary some in width as it can float on the flat 19 of the opposite track.

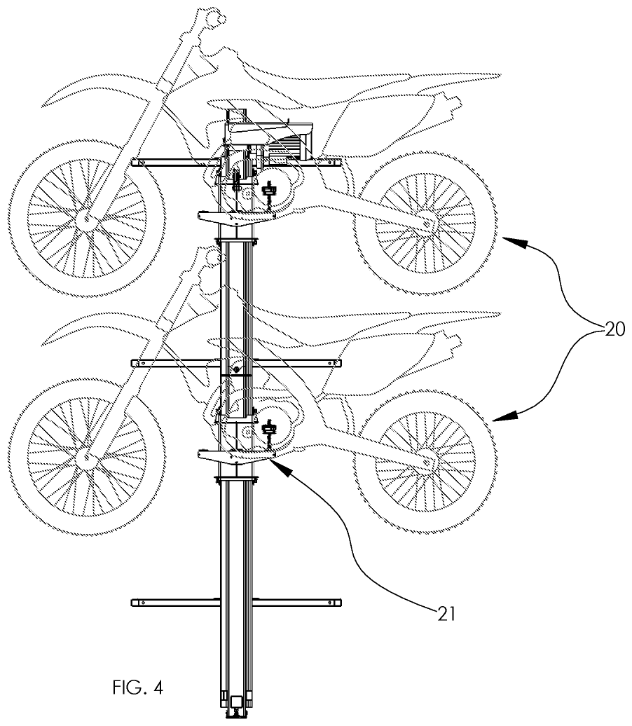

FIG. 4 depicts motorcycles 20 secured to the motorcycle lift accessory platforms 21 to demonstrate how carriages and their cargo are raised in a sequentially stacked formation.

1. A lift system comprising:
A column that may be mounted to a wall or other supporting structure or be free standing; one or more detachable carriages that travel up and down the column; a means by which to secure accessory attachments to the carriages such as but not limited to a receiver tube;

2. The lift system of claim 1, wherein the column has guide rails to guide the carriages up and down the column

3. The lift system of claim 2, wherein the guide rails are designed such that one side guides a roller of a carriage while allowing the roller of the opposite side of the carriage to move laterally.

4. The lift system of claim 1, wherein a hoist or other mechanism is used to cause the carriage/s to travel up and down the column.

5. The lift system of claim 1 further comprising various accessory attachments that are removably attached to a carriage for the purpose of configuring the lift for specific lifting applications.

6. The lift system of claim 1 wherein the column is segmented and extensions can be removably attached for the purpose of extending the height of the column.
